(19) United States
(12) Patent Application Publication
(10) Pub. No.: US 2014/0149370 A1
(43) Pub. Date: May 29, 2014

(54) SYSTEM FOR ANALYZING ACCESS PATH TO ACCESS TARGET FILE IN IMAGE AND METHOD THEREOF

(71) Applicants: INVENTEC CORPORATION, Taipei (TW); INVENTEC (PUDONG) TECHNOLOGY CORPORATION, Shanghai (CN)

(72) Inventor: Dong Hai LI, Shanghai (CN)

(21) Appl. No.: 13/794,894

(22) Filed: Mar. 12, 2013

(30) Foreign Application Priority Data
Nov. 29, 2012 (CN) 201210501617.2

(51) Int. Cl. G06F 17/30

(52) U.S. Cl. CPC G06F 17/30082
USPC 707/705

(57) ABSTRACT

A system for analyzing an access path to access a target file in an image and the method thereof are provided. By determining whether the image includes the target file based on the access path and determining an entity path and an image path from the access path when the image includes the target file, the invention opens the image according to the entity path, and accesses the target file in the image according to the image path. The system and the method can directly access the target file in the image on the server, achieving the effects of reducing waste of network resources and shortening download time.

### BACKGROUND OF THE INVENTION

1. Field of Invention

The invention relates to a file access system and method, in particular, to a system for analyzing an access path to access a target file in an image and the method thereof.

2. Related Art

The network drive service platform provides users the service of uploading files to a network drives. Users can upload any type of files to a network drive service platform, such as data files, multimedia files, applications, system setting files, and even images. The image file typically contains an independent directory structure and a number of files in various directories. Thus, the images typically have larger file sizes.

In addition to allowing users to upload files, the network drive service platform also allows users to download and delete the uploaded files. Moreover, some network drive service platforms also provide the functions of online browsing data file or online playing multimedia files.

However, current network drive service platforms do not provide the function of analyzing images. That is, if a user wants to access some files contained in an image file, the entire image file has to be downloaded from the network hard drive service platform to the device of the user. The user's device then analyzes the downloaded image file, in order to obtain files in the image file. If the user only wants to access a small portion of the image file, downloading the entire image certainly results in the waste of network resources and downloading time.

In summary, the prior art has the problem that one must download the entire image from the network drive service platform before accessing files in the image. It is imperative to provide an improved technical means to solve this problem.

### SUMMARY OF THE INVENTION

In view of the foregoing, the present invention discloses a system for analyzing an access path to access a target file in an image and the method thereof.

The disclosed system is used on a server for the connections of clients and having a storage media. The system includes at least: a transmission module for receiving a file access request for accessing a target file sent from a client; a path analyzing module for determining whether the target file is contained in the image according to the access path contained in the file access request and, when the target file is contained in the image, determining an entity path and an image path contained in the access path; a file access module for opening the image based on the entity path; an image processing module for analyzing the image opened by the file access module and accessing the target file in the image analyzed according to the image path.

The disclosed method is used on a server for the connections of clients and comprises at least the steps of: receiving a file access request sent from a client for accessing a target file; determining whether the target file is contained in the image according to the access path contained in the file access request; determining the entity path and the image path contained in the access path when the target file is contained in the image; opening the image according to the entity path; analyzing the opened image and accessing the target file in the analyzed image according to the image path.

The disclosed system and method differ from the prior art in that the invention determines whether the target file is contained in the image based on the access path and determines the entity path and the image path contained in the access path. The invention opens the target file in the image in accordance with the image path. The invention solves the problem existing in the prior art, and can reduce waste of network resources and downloading time.

### BRIEF DESCRIPTION OF THE DRAWINGS

The invention will become more fully understood from the detailed description given herein below illustration only, and thus is not limitative of the present invention, and wherein:

FIG. 1 is a structural diagram of the system for analyzing an access path to access a target file in an image according to the invention.

FIG. 2A is a flowchart of the method for analyzing an access path to access a target file in an image according to the invention.

FIG. 2B is a flowchart of the detailed method of analyzing an image according to the invention.

### DETAILED DESCRIPTION OF THE INVENTION

The present invention will be apparent from the following detailed description, which proceeds with reference to the accompanying drawings, wherein the same references relate to the same elements.

The invention allows a user to directly access the target files contained in an image stored on a remote server. The user does not need to first download the image in order to access the target files therein. The server usually provides the network hard disk service, in order to for the user to manipulate on the client end to access files stored on the network disks. However, the present invention is not limited to this. Any method allowing the user to store files and download the stored files is within the scope of the present invention.

The “image” referred herein is a file that contains one or multiple files. Examples include the disk images, ISO images, zipped packages, software packages. The image herein is not limited to such examples.

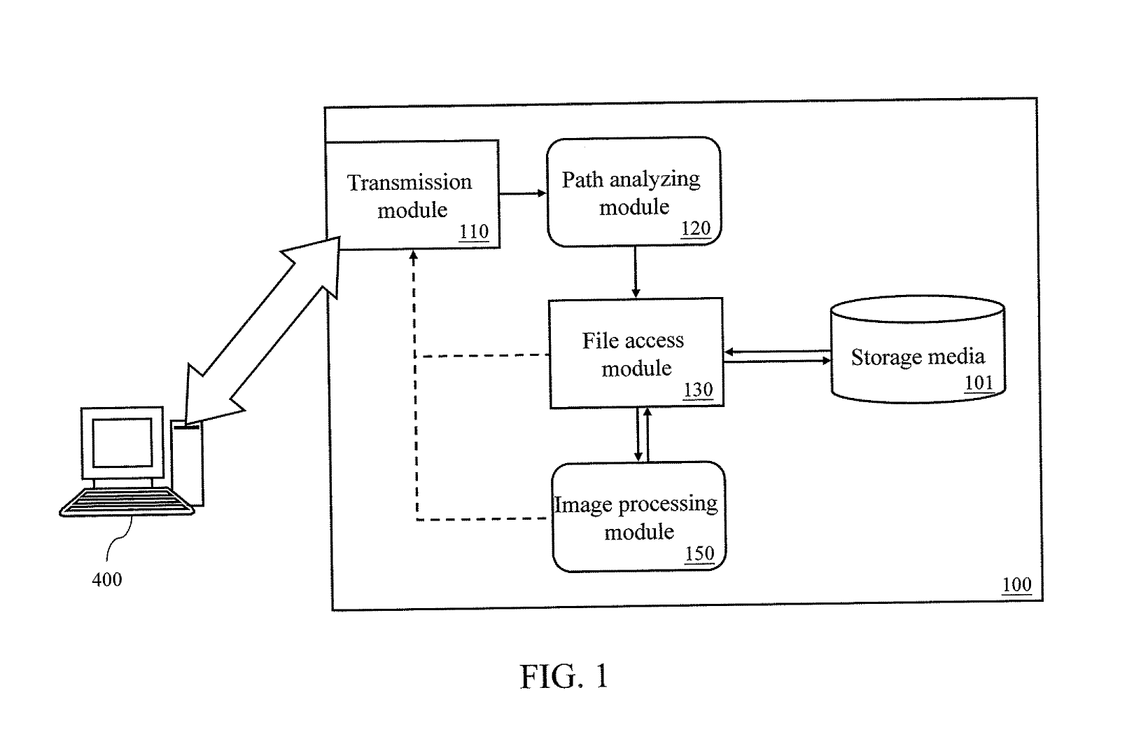

FIG. 1 is a structural diagram of the system that analyzes the access path to access target files in an image. As show in the drawing, the disclosed system includes a transmission module 110, a path analyzing module 120, a file access module 130, and an image processing module 150.

The transmission module 110 receives a file access request sent from a client 400, The file access request received by the transmission module 110 contains the access path of the target file that the client 400 wants to access.

If the target file to be accessed by the client 400 can be directly accessed in the storage media 101 of the server 100, the access path contained in the file access request is the path to access the target file on the server 100. This path is the common path to access the target file, such as “/user/documents/target.txt”. If the target file is contained in an image, it means that the image has to be first processed before one can access the target file. That is, the target file accessed by the client 400 can not be directly accessed by the server 100. Therefore, the access path contained in the file access request can contain the path to access the image on the server 100 and the path of the target file in the image, e.g., “/user/documents/backup.iso/config/network.xml”, where “user/documents/backup.iso” is the path of the image containing the target file on the server 100, called the entity path in the invention. “/config/network.xml” indicates the path of the target file in the image, called the “image path” in the invention.

It is worth mentioning that in the present invention, the image containing the target file can be contained in another image. For example, the target file “DSC0208.raw” is contained in the image “photo.zip”, while the image “photo.zip” is contained in another image “backup.iso”, and the image “backup.iso” is stored in the directory “/user/documents/” on the server 100. Thus, to access the target file “DSC0208.raw”, the access path should be “/user/documents/backup.iso/photo.zip/DSC0208.raw”. In fact, the number of times an image is contained in other images is not limited by the present invention. That is, in the above example, the image file “backup.iso” can be contained in other images.

The transmission module 110 can also send the access result generated after the image processing module 150 or the file access module 130 accesses the target file to the client 400. Generally speaking, if the file access request transmitted from the client 400 means that the client wants to write data to the target file, the access result transmitted by the transmission module 110 is the result of written data. If the file access request transmitted from the client 400 means that the client wants to read data from the target file, the access result transmitted by the transmission module 110 is the result of data being read. Nevertheless, the access result transmitted by the transmission module 110 is not limited to the above-mentioned.

The path analyzing module 120 determines from the access path contained in the file access request received by the file access module 110 whether the target file to be accessed by the client is contained in the image. After determining that the target file is contained in the image, the path analyzing module 120 also determines the entity path of the image on the server 100, as well as the image path of the target file in the image.

The path analyzing module 120 can determine whether the access path contains only the file name of one file. It can also determine whether the directory names of various directories in the access path are file names, in order to determine whether the target file is contained in the image. But the method used by the path analyzing module 120 to determine whether the target file is contained in the image is not limited to the above-mentioned. For example, when the access path is “/user/document/target.txt” or “/user/document/backup.iso” (assuming backup.iso is an image), the path analyzing module 120 can determine that the target file desired by the client 400 is not contained in the image because the access path has only one file name or the directory “/user” and “/documents” in the access path are not file names. When the access path is “/user/document/backup.iso/config/network.xml”, the path analyzing module 120 determines that the target file desired by the client 400 is contained in the image because the access path contains the two file names “backup.iso” and “network.xml” or because the directory name “/backup.iso” in the access path is actually an image “backup.iso”. In this case, the path analyzing module 120 also determines that the entity path is from the beginning of the access path to the file name “backup.iso”, that is, “/user/document/backup.iso”. The image path is from the file name “backup.iso” to the end of the access path, that is, “config/network. xml”.

After the path analyzing module 120 determines whether the target file desired by the client 400 is contained in the image, the file access module 130 opens the image file containing the target file and stored in the storage media 101 based on the entity path determined by the path analyzing module 120.

When the path analyzing module 120 determines whether the target file desired by the client 400 is not contained in the image, the file access module 130 also accesses the target file from the storage medial 01 according to the access path contained in the file access request.

The image processing module 150 analyzes the image opened by the file access module 130. Generally speaking, the image processing module 150 first determines the coding type of the image opened by the file access module 130. According to the determined coding type, the image processing module 150 uses the corresponding decoding algorithm to decode the image, thereby analyzing various directories and files contained in the image. Besides, the image processing module 150 accesses the target file in the image based on the access path determined by the path analyzing module 120.

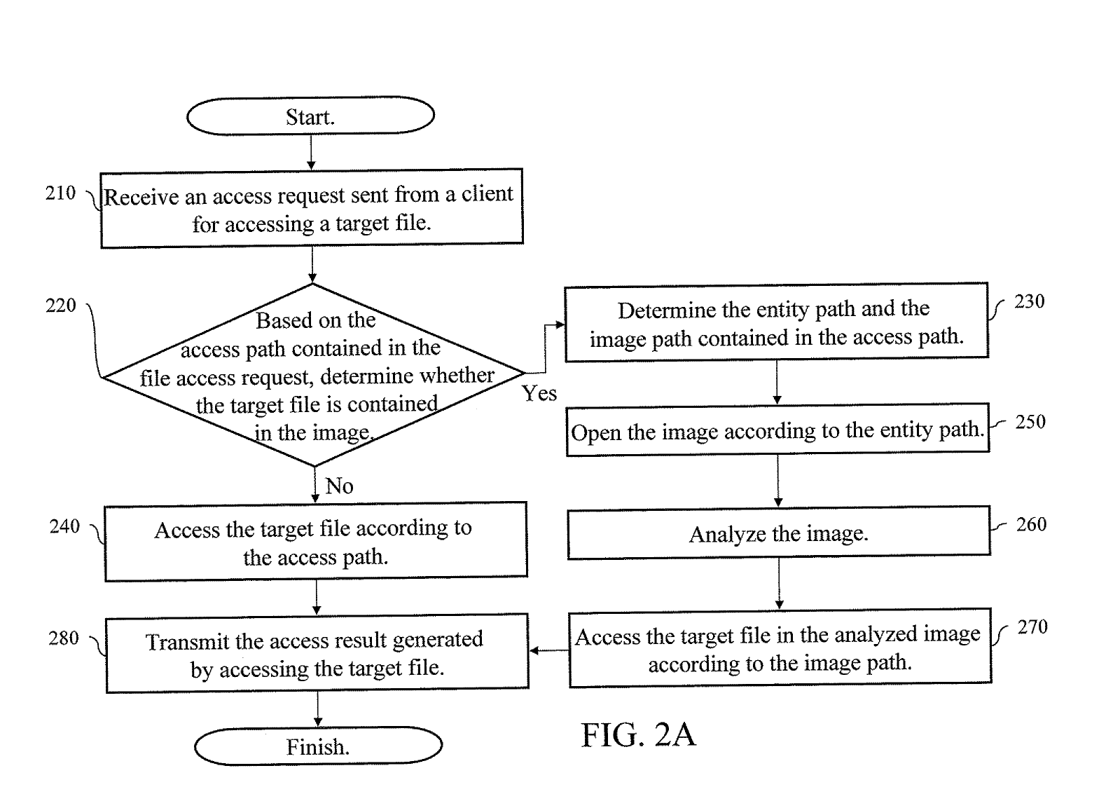

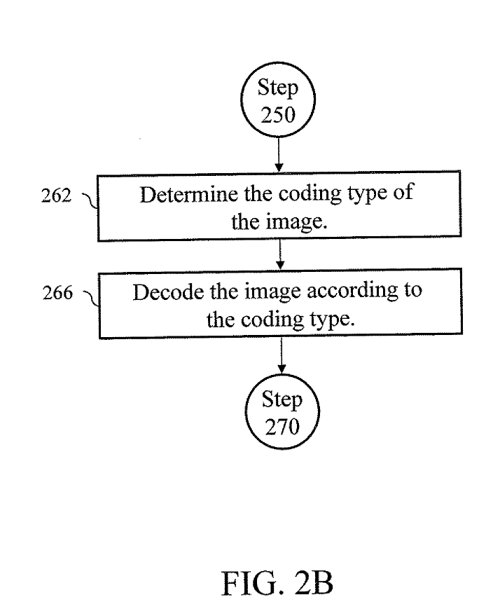

In the following, an embodiment is used to explain how the disclosed system and method operate. Please refer to FIG. 2A, which is a flowchart of analyzing the access path to access the target file of the image according to the invention. In the present invention, the server 100 is assumed to be a file server that provides network disk drive service. Nevertheless, the invention is not limited to this possibility.

When the client 400 wants to access a target file in the storage media 101 of the server 100, the file access request for accessing the target file is sent to the server 100. Thus, the transmission module 110 can receive the file access request sent from the client 400 (step 210). In this embodiment, suppose the target file desired by the client 400 is “network.xml”, the target file is contained in the image “system.iso”, and the image is stored in the directory “/users/mana/backup” on the server 100. Consequently, the file access request sent from the client 400 contains the access path “/users/mana/backup/system.iso/network.xml”.

After the transmission module 110 receives the file access request, the path analyzing module 120 can also determine whether the target file is contained in the image file according to the access path contained in the file access request received by the file transfer module 110 (step 220). When the target file is contained in the image, the invention determines the entity path and the image path (step 230). In this embodiment, it is assumed that the path analyzing module 120 checks whether various directories in the access path are actually files. That is, the path analyzing module 120 checks one by one whether the directories “users”, “mana”, “backup”, and “system.iso” in the access path are file names. The directories “users”, “mana”, and “backup” are indeed directories on the server 100, but “system.iso” is a file. Therefore, the path analyzing module 120 determines that the target file “network.xml” is contained in the image “system.iso”, and the entity path is “/users/mana/backup/system.iso ” while the image path is “/network.xml”,

After the path analyzing module 120 determines that the entity path and the image path contained in the access path (step 230), the file access module 130 opens the image containing the target file according to the entity path obtained by the path analyzing module 120 (step 250). In this embodiment, the file access module 130 opens the image “backup.iso” stored in the directory “/users/mana/backup” on the server 100 based on the entity path “/users/mana/backup/system.iso”.

After the file access module 130 opens the image according to the entity path obtained by the path analyzing module 120 (step 250), the image processing module 150 analyzes the image opened by the file access module 130 (step 260). In the present embodiment, it is assumed that the image processing module 150 follows the procedure shown in FIG. 2B to first determine the coding type of the opened image “backup.iso” (step 262). Since the coding type of the image “ backup.iso” is a disk image, the image processing module 150 uses the coding method corresponding to the coding method for making the image “backup.iso” to decode the image “backup.iso” (step 266), thereby obtaining the directory structure and tiles contained in the image “backup.iso”.

Returning to FIG. 2A, after the image processing module 150 obtains the image opened by the file access module 130 (step 260), the image processing module 150 can access the target file in the image according to the image path determined by the path analyzing module 120 (step 270). Therefore, using the present invention, the user can read the target file contained in the image via the server 100 and download the target file from server 100 without downloading the complete image.

In this embodiment, the image processing module 150 accesses the target file “network.xml” under the root directory of the image “backup.iso”. If the client 400 wants to write data into the target file, such as increasing the settings in the target file “network.xml”, the image processing module 150 writes the data into the target file and the file access module the 130 uses the target file “network.xml” written with the data to replace the original target file “network.xml” in the image “backup.iso”. The same coding method for making the image “backup.iso” is used to encode the image “backup.iso” with the replaced target file “network.xml”. The newly encoded image “backup.iso” is stored in the storage media 101 of the server 100, followed by generating the message of successful or failed data writing. If the client 400 wants to read the contents of the target file, the image processing module 150 reads the contents of the target file. The contents read out by the image processing module 150 are the access result of the invention.

After the image processing module 150 accesses the target file in the image (step 270), the transmission module 110 sends the access result generated as the image processing module 150 accesses the target file back to the client 400 (step 280). In this embodiment, the access result sent by the transmission module 110 is the contents of the target file read out by the image processing module 150, or the message of successful or failed when data writing.

In the above embodiment, the target file desired by the client 400 is “/users/mana/note.txt” on the server 100. After the transmission module 110 receives the file access request (step 210), the path analyzing module 120 determines whether the target file is contained in the image file based on the access path “/users/mana/note.txt” contained in the file access request (step 220).

Since “users” and “mana” in the access path are indeed directories on the server 100, the path analyzing module 120 determines that the target file is not contained in the image. Thus, the file access module 130 directly uses the access path “/users/mana/note.txt” contained in the file access request to access the target file “note.txt” under the directory “/users/mana” of the server 100 (step 240). The transmission module 110 sends the access result generated after the file access module 130 accesses the target file back to the client 400 (step 280).

In summary, the invention differs from the prior art in that the invention determines whether the target file is contained in the image file according to the access path, and determines the entity path and the image path contained in the access path. The entity path is used to open the image. The image path is used to access the target file from the image. This technical means solves the problem in the prior art that one has to download the complete image before accessing files therein. The invention achieves the goal of reducing the waste of network resources and downloading time.

Moreover, the disclosed method of analyzing the access path to access the target file in the image can be implemented in hardware, software, or a combination of hardware and software. It can also be implemented in a computer system in a centralized manner, or in a distributed way among several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for analyzing an access path to access a target file in an image used on a server for the connections of at least one client, the method comprising the steps of:
receiving a file access request for accessing a target file sent from the client;
determining whether the target file is contained in an image according to an access path contained in the file access request;
when the target file is contained in the image, determining an entity path and an image path contained in the access path;
opening the image according to the entity path; and
analyzing the opened image and accessing the target file in the analyzed image according to the image path.

2. The method of claim 1 further comprising the step of accessing the target file according to the access path when the target file is not contained in the image.

3. The method of claim 1 further comprising the step of determining a coding type of the image and decoding the image according to the coding type.

4. The method of claim 1, wherein the step of determining whether the target file is contained in an image according to the access path contained in the file access request determines whether various directories in the access path are file names of the image or determines whether the access path only contains one file name.

5. The method of claim 1, wherein the step of accessing the target file in the analyzed image according to the image path is followed by the step of transmitting the access result generated by accessing the target file to the client.

6. A system for analyzing an access path to access a target file in an image used on a server for the connection of at least one client, the system comprising:
a transmission module for receiving a file access request for accessing a target file sent from the client;
a path analyzing module for determining whether the target file is contained in an image file according to an access path contained in the file access request and, when the target file is contained in the image, determining an entity path and an image path contained in the access path;
a file access module for opening the image according to the entity path; and
an image processing module for analyzing the image opened by the file access module and accessing the target file in the analyzed image according to the image path.

7. The system of claim 6, wherein the file access module further accesses the target file according to the access path when the path analyzing module determines that the target file is not contained in the image.

8. The system of claim 6, wherein the image processing module further determines a coding type of the image and uses the coding type to decode the image.

9. The system of claim 6, wherein the path analyzing module determines whether various directories in the access path are file names in the image or determines whether the access path contains only one file name.

10. The system of claim 6, wherein the transmission module further transmits the access result generated as the image processing module or the file access module accesses the target file to the client.
